(19) United States
(12) Patent Application Publication
(10) Pub. No.: US 2004/0116025 A1
(43) Pub. Date: Jun. 17, 2004

(54) Air permeable garment and fabric with integral aerosol filtration

(76) Inventors: Mark A. Gogins, Roseville, MN (US); Hoo Young Chung, Bloomington, MN (US); Douglas G. Crofoot, Burnsville, MN (US); Ismael Ferrer, Minneapolis, MN (US); Dmitry Luzhansky, Eden Prairie, MN (US)

Correspondence Address: MERCHANT & GOULD PC, P.O. BOX 2903, MINNEAPOLIS, MN, 55402-0903, US

(21) Appl. No.: 10/322,366

(22) Filed: Dec. 17, 2002

(51) Int. Cl. B32B 3/00; B32B 27/14; B32B 3/26

(52) U.S. Cl. 442/340; 442/351; 442/399; 442/400; 442/370; 442/373; 428/315.9

(57) ABSTRACT

A multilayer fabric for protection from aerosol and gas phase agents comprising a bilayer structure comprising an unfilled Fine fiber layer substantially free of materials within the pores of the Fine fiber layer secured to an outer shell, the Fine fiber layer acting as an aerosol filter, and an optional interior fabric layer having a reactive layer for the removal of gas phase agents.

### FIELD OF THE INVENTION

An air permeable fabric having an integral aerosol filtration barrier can be used in a variety of protective garments, surgical drapes, patient gowns and other structures. The structures act to prevent the passage of aerosols through the fabric. The aerosols could include chemical agents, biological agents, toxic industrial agents such as asbestos or lead, or naturally occurring aerosols, nuisance dust or radioactive particles. While the garment is a barrier to harmful agents, the fabric possesses air permeability for comfort of the wearer or for equalization of pressure across the barrier fabric. The fabric and garments thereof are well suited for military applications including protection from chemical and biological warfare agents and radioactive particles.

### BACKGROUND OF THE INVENTION

Henn et al., U.S. Pat. No. 5,026,591; Gore et al., U.S. Pat. No. 4,194,041; Gohlke, U.S. Pat. No. 4,344,999; Worden et al., U.S. Pat. No. 4,443,511; Gore, U.S. Pat. No. 3,953,566; Tomoda et al., U.S. Pat. No. 4,133,927; Nomi, U.S. Pat. No. 4,692,369; Sato et al., U.S. Pat. No. 4,539,255; Henn, U.S. Pat. No. 4,532,316; and Maples, U.S. Pat. No. 6,395,383.

Various membrane-containing fabrics are available that are durable and an efficient aerosol barrier, but they do not provide the air permeability desired. As shown by the preceding patent disclosures, in large part, most barrier fabrics are made by either coating or filling a stretched film or membrane often called a “scaffold” material comprising a polytetrafluoroethylene (PTFE) material. The PTFE material is then filled, partly filled, or coated with a filling material, which preferably seals off or blocks a substantial portion of the pores in the scaffold. The filling material is typically a resin that may have a relatively high moisture vapor transmission rate. Alternately, the filling material may be a special chemistry that allows diffusion on water vapor but prevents diffusion of other gases such as chemical warfare and industrial toxic agents. These barrier fabrics are sometimes called “semi-permeable” because they are permeable to certain gases via diffusion, but impermeable to other gases and impermeable to bulk flow of air through the garment.

Other barrier fabrics function by what is generally referred to as an “impermeable” material. A suitable material of this type, such as butyl rubber, will exhibit low transmission of most gases, including water vapor. These materials are often referred to as non-breathable.

When used in the construction of protective clothing, both impermeable and semi-permeable fabrics limit the flow of bulk air through the fabric. The semi-permeable varieties in general allow for the diffusion of water vapor, making them somewhat more comfortable for the wearer, by allowing water vapor from evaporated sweat to diffuse through the filling material. When used in protective clothing, both impermeable and semi-permeable materials can retard the transfer of heat from the human body to the ambient environment. Without significant transfer of heat from the body, the wearer may experience significant discomfort, and eventually be subject to heat stroke and even death.

Jones et al., U.S. Pat. No. 4,932,078, describes garment fabrics comprising a PTFE material laminated to permeable backing material. The garment prevents the flow of particulate matter and allows the passage of water vapor or air, but includes PTFE material with small pores and poor air permeability characteristics. This reference also discloses using higher air permeability materials in breathable masks. These materials are designed for filtering inhaled or exhausted air, but not for use in bulk garment or fabric applications.

Blucher et al., U.S. Pat. No. 4,510,193 and Smolik et al., U.S. Pat. No. 5,662,991, discloses the use of adsorption/absorption materials with fabrics to eliminate gaseous and biocidal agents, but fail to disclose using this fabric system with a means for eliminating aerosols. Smolik et al. also discloses using coated PTFE membranes, but those membranes do not provide air permeability.

### BRIEF DISCUSSION OF THE INVENTION

We have found that a fabric can act as a barrier to the transport of hazards. The fabric can be used as protective suits or clothing or other barrier uses such as containers of hazardous materials. We have found a multilayer fabric that can provide comfort through air permeability and protection from gas phase agents and protection from aerosol penetration. The resulting fabric provides substantial protection from the penetration of aerosol particulates through the fabric while maintaining substantial air permeability and comfort for the wearer over an extended period of use. The air permeable, but particulate resistant structure, typically comprises a fine fiber layer. The non-woven structure typically comprises a woven or non-woven fabric layer having in close proximity thereto, a fine fiber layer. The fine fiber layer can be an electrospun or melt blown layer formed from fibers having a diameter from about 0.001 to about 2 microns or about 0.05 to about 1 micron, having a basis weight of about 1.2×10⁴ to 3.5 mg/cm² and having an average pore size of about 0.1 to 10 microns or about 2 to 3 microns. The fine fiber layer is typically substantially uniformly formed in random orientation and is typically associated with a woven or non-woven fabric layer. The fine fiber layer, having small pore sizes, can act as a barrier to aerosols, or, using its hydrophobic nature, repel liquid agents.

In one mode of operation, the fine fiber layer can be electrospun or melt blown directly on to and adhered to the associated woven or non-woven fabric layer. The fine fiber layer and the woven or non-woven fabric layer provides substantial air permeability to enhance wearability by the user. The combined layers provide a comfort layer having size and permeability such that the wearer can survive the hazardous conditions barred by the fabric but also can survive the body heat generated by substantial activity while wearing the suit without serious physiological harm from dehydration, heat stroke or other physiological problems. The fine fiber layer can be included with a further adsorbent, absorbent, or reactive layer that can react with chemical or biological hazardous materials.

Two basic options for the multilayer fabrics are: (1) a fabric for aerosol filtration only; and (2) adding a layer for filtration or neutralization of gas-phase chemical agents to the aerosol filtration fabric. As an example, an aerosol protective fabric might be used for asbestos abatement where there are no chemical threats present, while the fabric may be further combined with an additional layer for mitigation of gas-phase chemicals combined with aerosols (e.g., a chemical/biological warfare situation.)

The objective is to develop durable chemical protective clothing fabrics containing nanofibers for protection against aerosolized chemical and biological agents. Nanofibers can be arranged in structures that are very efficient barriers to aerosol particles, but still allow excellent air permeability.

Nanofiber constructions require the necessary combination of porosity, fiber size, elasticity, tensile strength, and adhesion to survive normal fabric usage. The commercial and military benefit is the addition of an aerosol protection capability to air permeable chemical suits without compromising their excellent thermal comfort properties. The civilian community will be able to take advantage of this technology for production of air permeable clothing that would protect HAZMAT, environmental cleanup personnel, farm workers, and others from aerosolized hazardous materials.

### BRIEF DISCUSSION OF THE FIGURES

FIG. 1 is a photo micrograph showing commercial nanofibers.

FIG. 2 is a photo micrograph showing nanofiber on spunbond non-woven.

FIG. 3 is a graph of data showing aerosol penetration versus particle size.

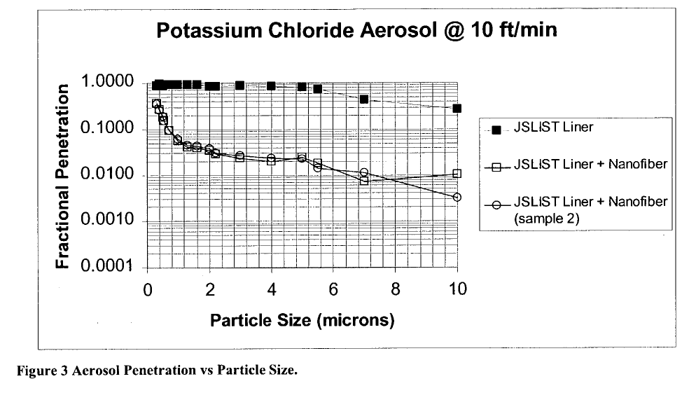

FIG. 4 is a graph of data showing media model: efficiency versus particle size.

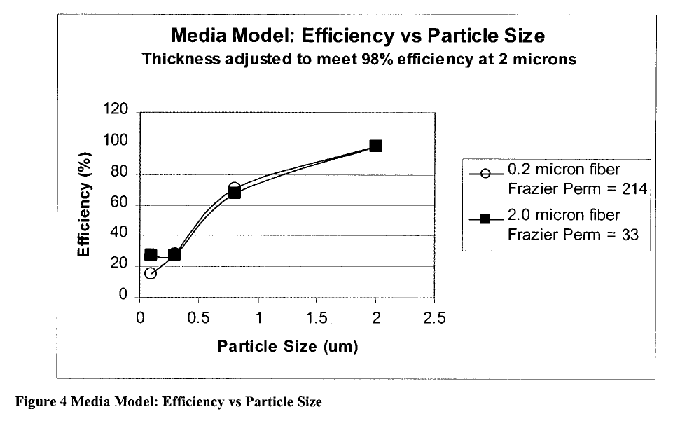

FIG. 5 is a graph of data showing media model: 20% solidity, 98% efficiency on 2 micron particles.

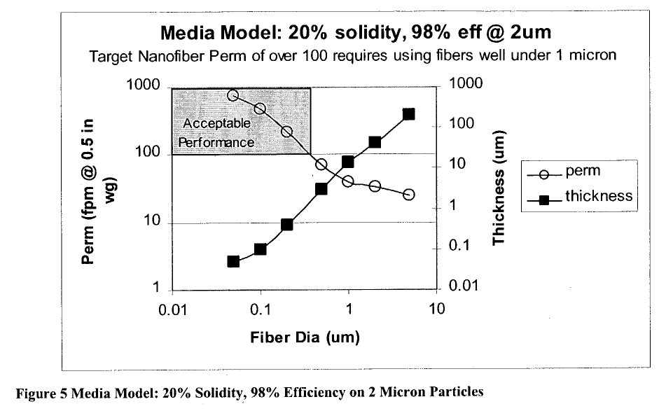

FIG. 6 is a photo micrograph showing low mag SEM of detergent captured on nanofiber layer.

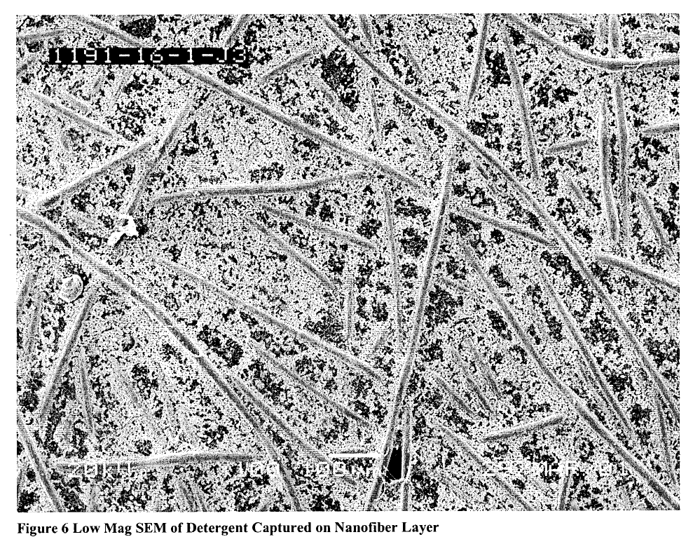

FIG. 7 is a photo micrograph showing high Mag SEM of detergent captured on nanofiber layer.

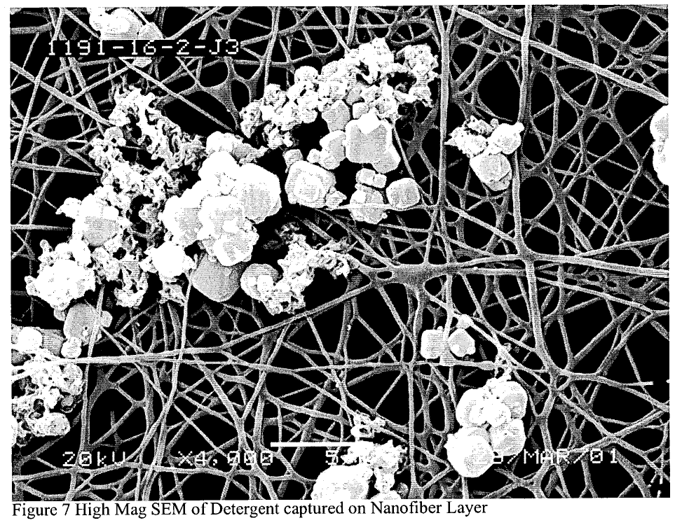

FIG. 8 is a photograph showing severe abrasion damage.

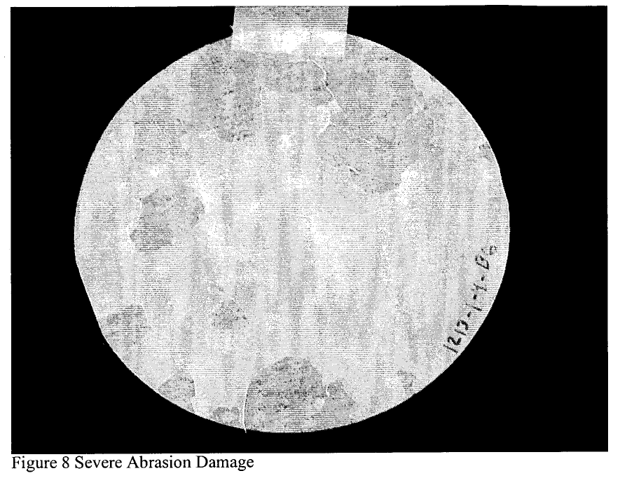

FIG. 9 shows a microscale composite strain test apparatus.

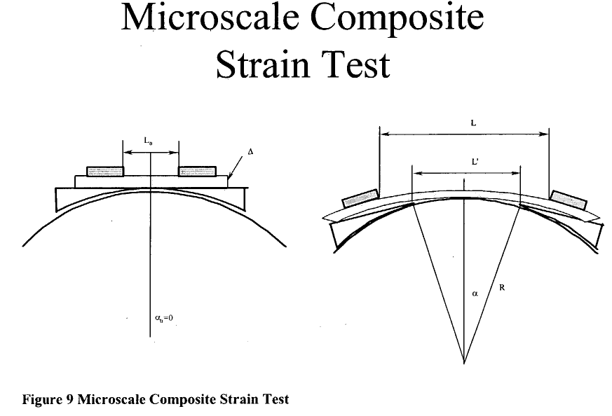

FIG. 10 is a photo micrograph showing ruptured nanofiber layer due to broken bonds of support fibers.

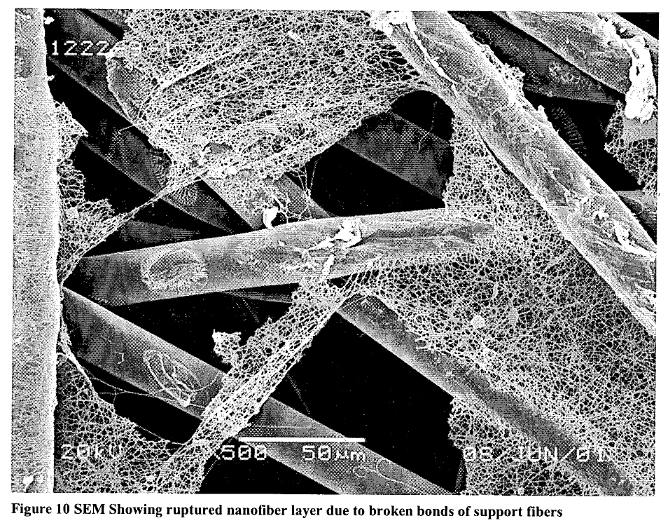

FIG. 11 is a photo micrograph showing nanofiber on Camo showing rupture due to loose fiber ends.

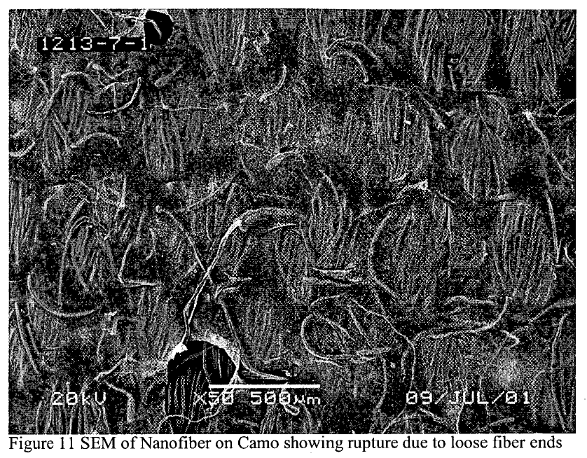

FIG. 12 is a photo micrograph showing a cross-section view of nanofiber on Cerex.

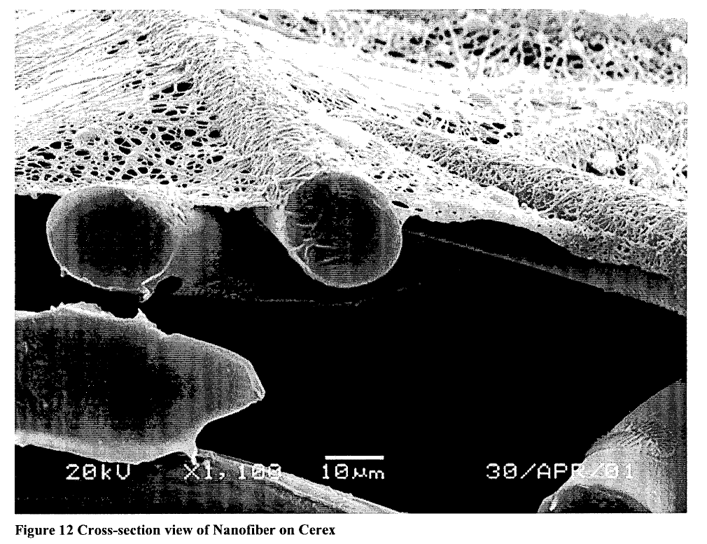

FIG. 13 is a photo micrograph showing face-to-face nanofiber on Cerex composite.

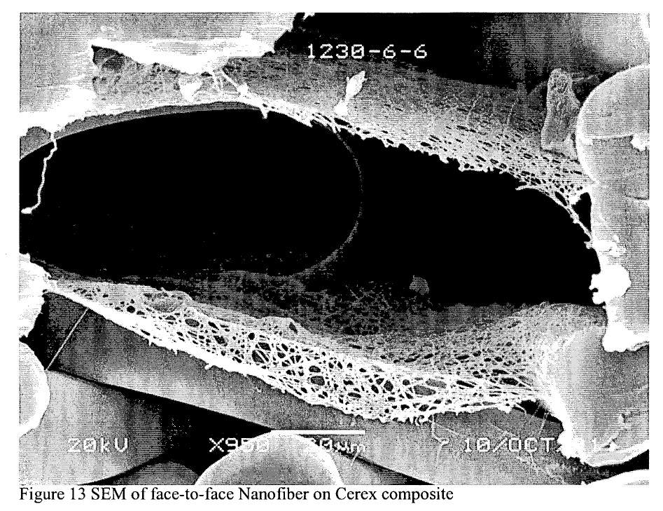

FIG. 14 is a photo micrograph showing silica dust captured on nanofibers during laundry.

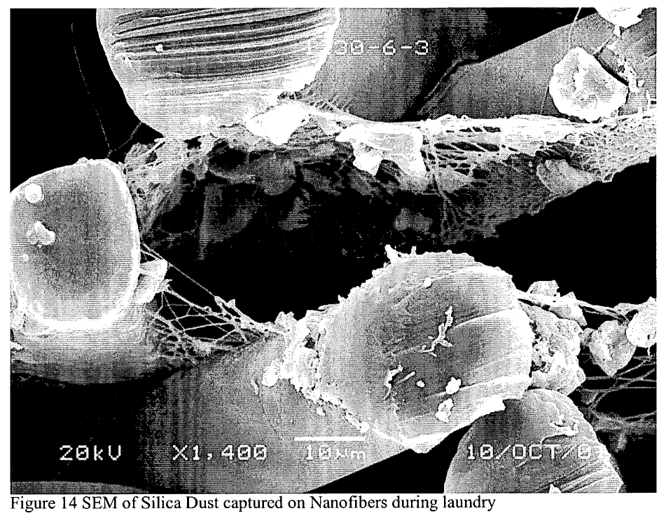

FIG. 15 is a graphic representation of data regarding pulse cleaning test: nanofiber on PE felt versus standard PE felt.

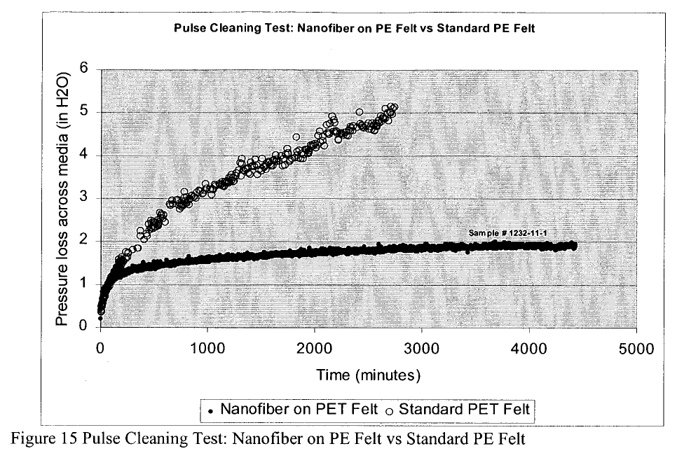

FIG. 16 is a graphic representation of data regarding abrasion on samples of nanofiber on 16 ounce polyester felt.

FIGS. 17-20 is a representation of the various multi layer fabrics of the invention.

### DETAILED DISCUSSION OF THE INVENTION

The invention resides in a fabric or in an article sewn from the fabric such as a garment. The fabric is a multilayer structure having substantial wearer comfort, but protects the wearer from the introduction of aerosol hazardous substances, and optionally from gaseous hazardous substances. More particularly, the multilayer fabric has a substantial air permeability, but acts as a substantial barrier to the penetration of aerosol and gaseous biological and chemical warfare agents through the fabric. The fabric can be incorporated into a variety of wearable items including hats, hoods, drapes, jackets, girdles, shorts, pants, socks, boots, underwear, outerwear, overcoats, raincoats, full body suits and other such garments. The fabric of this invention also have a numerous non-garment applications, such as tents, canopies, backpacks, storage bags, tarps, and body bags, etc.

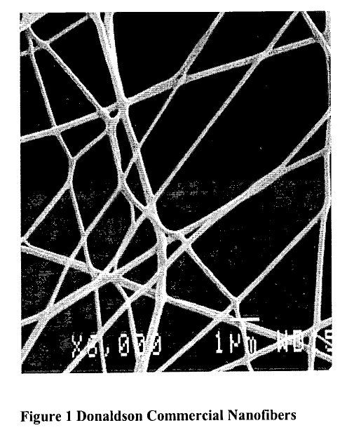

The multilayer fabric typically comprises a fine fiber (as shown in FIG. 1) layer having defined air permeability due to the presence of pores having a defined pore size in the fine fiber layer. These fine fibers can be produced by a number of means including electrostatic spinning, melt spinning, melt blowing, or splittable “islands in a sea” methods. Such a layer has a pore size sufficiently small to act as a barrier to the introduction of aerosol materials through the barrier layer, but has sufficiently large pore sizes to provide sufficient air permeability for comfort.

The multilayer fabric typically includes an outer shell, either a woven or non-woven material that can act to protect the fine fiber layer from damage, contamination or wear. Often the outer shell is combined with the fine fiber layer using a variety of manufacturing techniques; however, such a combination is preferably manufactured using either direct application or adhesive lamination technology. In other multilayer constructions, the fine fiber layer might be layered next to shell material, and not laminated. For example, the fine fiber layer might be sewn together with the shell. The shell should be understood to be the outer layer of this protective material, it may of course be worn in many configurations with other garments, including as an undergarment.

The multilayer fabric of the invention can include an inner fabric layer. The inner fabric layer can be comfortable to wear for a user. Such a material is either a woven or non-woven fabric (which includes knitted materials) and is typically selected for its wearer comfort, utility and manufacturing the overall multilayer structure and permeability. Such fabric layers act to provide comfort to the wearer and to protect the multilayer structure from damage, contamination or wear.

The fabric can further comprise a reactive layer that includes an absorbent or adsorbent material that is active in absorbing, adsorbing and/or deactivating gaseous or liquid chemical or biological warfare agents from the ambient atmosphere as it penetrates the fabric. A variety of active chemical treatment materials and active and/or passive adsorbents or absorbents can be present in such layer.

Such multilayer fabrics have the following preferred properties: (1) increased aerosol protection; (2) adequate air permeability; and (3) optional absorbent, adsorbent, and/or biocidal filtration capability.

In addition to the waterproofness and permeability of protective articles, it is desirable for such articles to have the distinguishing characteristic of stretch. Stretch offers to the consumer many advantages such as comfort, fit, reduced pucker, improved wrinkle resistance, the need for fewer sizes, alterations and greater design flexibility. In its broad concept, “stretch” might be defined as the comfort factor in textile products. In specific textile applications, the technology of stretch relates to fibers, yarns and fabrics; and the extent of its presence in textile products is a matter of its functional advantage for a particular end use.

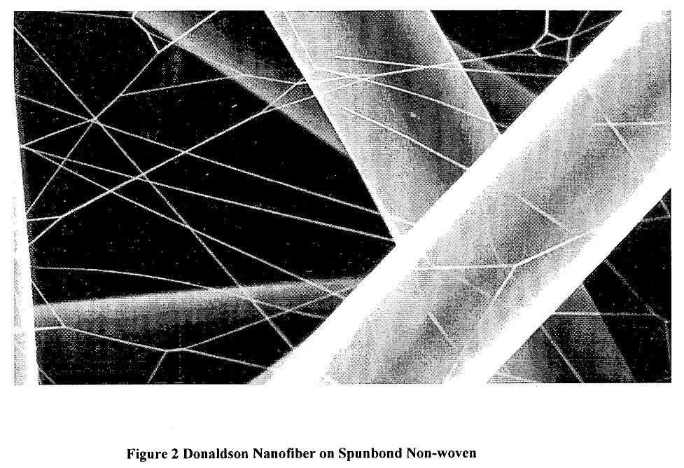

The multilayer fabric of the invention includes a fine fiber layer or an expanded membrane found on a substrate (see FIG. 2) forming an aerosol barrier. The fine fiber layer has a defined air permeability of about 0.5 fpm (cubic feet per minute), ft³-min⁻¹ to about 300, preferably about 10 to about 100. Air permeability is measured according to ASTM D737-96. The fine fiber layer has a defined pore size that is typically between about 0.5 microns to about 10 microns, preferably between about 2 microns to about 3 microns. The pore size is measured by ASTM F316-86. The fine fiber layer has a filtration efficiency (LEFS) of greater than about 50%, preferably greater than about 80% to about 99.99%. Air filtration efficiency is measured according ASTM F1215-89 using 0.8 micron polystyrene latex spheres at an air velocity of 20 ft-min⁻¹.

The fine fiber layer of the invention comprises a layer having a layer thickness of about 0.05 to 30 microns, a fiber diameter of about 0.05 to 1 micron, a basis weight of about 1.2×10⁻⁴ to 3.5 mg-cm² and a pore size that ranges from about 0.5 to 20 microns.

For the purpose of this patent application, the term “fine fiber” refers to a fiber having an indeterminate length but a width of less than about 5 microns often, less than about 1 micron. In the barrier fine fiber layer, the fine fiber is formed into a randomly oriented mesh of fiber having the defined pore size in a layer that substantially covers a surface of the fabric substrate. Preferred fine fiber add-on parameters are as follows:

| Dimensions | Range |
|---|---|
| Layer thickness (micron) | 0.1 to 5 |
| Solidity % | 5 to 40 |
| Density (gm-cm⁻³) | 0.9 to 1.6 (1.2 to 1.4) |
| Basis wt. (mg-cm⁻²) | 1.2 × 10⁻⁴ to 3.5 |

The invention relates to polymeric compositions with improved properties that can be used in a variety of applications including the formation of nanofibers, fiber webs, fibrous mats, etc.

Polymeric materials have been fabricated in non-woven and woven fabrics, fibers and microfibers. The polymer materials that can be used in the fine fiber or the polymeric fiber fabric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms. Preferred addition polymers tend to be glassy (a Tg greater than room temperature). One class of polyamide condensation polymers include nylon materials. The term “nylon” is a generic name for all long chain synthetic polyamides. Typically, nylon nomenclature includes a series of numbers such as in nylon-6,6 which indicates that the starting materials are a C₆ diamine and a C₆ diacid (the first digit indicating a C₆ diamine and the second digit indicating a C₆ dicarboxylic acid compound). Another nylon can be made by the polycondensation of epsilon caprolactam in the presence of a small amount of water. This reaction forms a nylon-6 (made from a cyclic lactam—also known as episilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a C₆ and a C₁₀ blend of diacids. A nylon 6-6,6-6,10 is a nylon manufactured by copolymerization of epsilonaminocaproic acid, hexamethylene diamine and a blend of a C₆ and a C₁₀ diacid material.

Block copolymers are also useful in the process of this invention. With such copolymers the choice of solvent swelling agent is important. The selected solvent is such that both blocks were soluble in the solvent. One example is an ABA (styrene-EP-styrene) or AB (styrene-EP) polymer in methylene chloride solvent. If one component is not soluble in the solvent, it will form a gel. Examples of such block copolymers are Kraton® type of styrene-b-butadiene and styrene-b-hydrogenated butadiene (ethylene propylene), Pebax® type of e-caprolactam-b-ethylene oxide, Sympatex® polyester-b-ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, can be solution spun with relative ease because they are soluble at low pressures and temperatures. However, highly crystalline polymers like polyethylene and polypropylene require high temperature, high pressure solvent if they are to be solution spun. Therefore, solution spinning of the polyethylene and polypropylene is very difficult. Electrostatic solution spinning is one method of making nanofibers and microfiber.

We have also found a substantial advantage to forming polymeric compositions comprising two or more polymeric materials in polymer admixture, alloy format or in a crosslinked chemically bonded structure. We believe such polymer compositions improve physical properties by changing polymer attributes such as improving polymer chain flexibility or chain mobility, increasing overall molecular weight and providing reinforcement through the formation of networks of polymeric materials.

In one embodiment of this concept, two related polymer materials can be blended for beneficial properties. For example, a high molecular weight polyvinylchloride can be blended with a low molecular weight polyvinylchloride. Similarly, a high molecular weight nylon material can be blended with a low molecular weight nylon material. Further, differing species of a general polymeric genus can be blended. For example, a high molecular weight styrene material can be blended with a low molecular weight, high impact polystyrene. A Nylon-6 material can be blended with a nylon copolymer such as a Nylon-6; 6,6; 6,10 copolymer. Further, a polyvinylalcohol having a low degree of hydrolysis such as a 87% hydrolyzed polyvinylalcohol can be blended with a fully or superhydrolyzed polyvinylalcohol having a degree of hydrolysis between 98 and 99.9% and higher. All of these materials in admixture can be crosslinked using appropriate crosslinking mechanisms. Nylons can be crosslinked using crosslinking agents that are reactive with the nitrogen atom in the amide linkage. Polyvinylalcohol materials can be crosslinked using hydroxyl reactive materials such as monoaldehydes, such as formaldehyde, ureas, melamine-formaldehyde resin and its analogues, boric acids and other inorganic compounds. dialdehydes, diacids, urethanes, epoxies and other known crosslinking agents. Crosslinking technology is a well known and understood phenomenon in which a crosslinking reagent reacts and forms covalent bonds between polymer chains to substantially improve molecular weight, chemical resistance, overall strength and resistance to mechanical degradation.

Fluoropolymer materials can be used in the fine fiber layers of the invention. Fluoropolymer elastomers are preferred. The most commonly available Fluoropolymer elastomer is the Viton® (DuPont) elastomeric composition. The preferred use of the fluoropolymer elastomer is in the dual layer of fine fiber. Such dual layers can comprise a fabric substrate, a first layer of fluoropolymer elastomer fine fiber followed by a second layer of a second fine fiber composition.

Viton exhibits good resistance to most oils, chemicals, solvents, and halogenated hydrocarbons, and an excellent resistance to ozone, oxygen, and weathering. Also referred to as fluoroelastomers, fluorocarbon compounds are thermoset elastomers containing fluorine. Fluorocarbons make excellent general-purpose fibers thanks to their exceptional resistance to chemicals, oils, and temperature extremes (−15° F. to +400° F.). Specialty compounds can further extend the low temperature limit down to −22° F. for dynamic seals and −40° F. in static applications. Fluorocarbons typically have good temperature performance, and resistance to ozone and sunlight. Over the last five decades, this remarkable combination of properties has prompted the use of fluorocarbon seals in a variety of demanding sectors. The useful temperature range of the materials is about −10° F. to +400° F. in continuous service.

Suitable haloelastomers for use herein include any suitable halogen containing elastomer such as chloroelastomers, bromoelastomers, fluoroelastomers, or mixtures thereof. Fluoroelastomer examples include those described in detail in Lentz, U.S. Pat. No. 4,257,699, as well as those described in Eddy et al., U.S. Pat. No. 5,017,432 and Ferguson et al., U.S. Pat. No. 5,061,965. The disclosures of each of these patents are totally incorporated herein by reference. The original commercial fluorocarbon, Viton® A, is the general-purpose type and is still the most widely used. It is a copolymer of vinylidene fluoride (VF2) and hexafluoropropylene (HFP). Generally composed of 60-70% fluorine, Viton A compounds offer excellent resistance against many automotive and aviation fuels, as well as both aliphatic and aromatic hydrocarbon process fluids and chemicals. Viton A compounds are also resistant to engine lubricating oils, aqueous fluids, steam, and mineral acids. Viton B fluorocarbons are terpolymers combining tetrafluoroethylene (TFE) with VF2 and HFP. Depending on the exact formulation, the TFE partially replaces either the VF2 (which raises the fluorine level to approximately 68%) or the HFP (keeping the fluorine level steady at 66%). Viton B compounds offer better fluids resistance than the Viton A copolymers. Viton GF fluorocarbons are tetrapolymers composed of TFE, VF2, HFP, and small amounts of a cure site monomer (Csm). Presence of the cure site monomer allows peroxide curing of the compound, which is normally 70% fluorine. As the most fluid resistant of the FKM types, Viton GF compounds offer improved resistance to water, steam, and acids.

Viton GFLT fluorocarbons are similar to Viton GF, except that perfluoromethylvinyl ether (PMVE) is used in place of HFP. The “LT” in Viton GFLT stands for “low temperature.” The combination of VF2, PMVE, TFE, and a cure site monomer is designed to retain both the superior chemical resistance and high heat resistance of the G-series fluorocarbons. In addition, Viton GFLT compounds (typically 67% fluorine) offer the lowest swell and the best low temperature properties of the types discussed here. Viton GFLT can seal in a static situation down to approximately −40° F. A brittle point of −50° F. can be achieved through careful compounding.

As described therein, the next generation of these fluoroelastomers include copolymers and terpolymers of vinylidenefluoride, hexafluoropropylene and tetrafluoroethylene, which are known commercially under various designations as VITON® A, VITON® E, VITON® E60C, VITON® E45, VITON® E430, VITON® B910, VITON® GH, VITON® B50, VITON® E45, and VITON® GF. The VITON® designation is a Trademark of E.I. DuPont de Nemours, Inc. Two preferred known fluoroelastomers are (1) a class of copolymers of vinylidenefluoride, hexafluoropropylene and tetrafluoroethylene, (such as a copolymer of vinylidenefluoride and hexafluoropropylene) known commercially as VITON® A, (2) a class of terpolymers of vinylidenefluoride, hexafluoropropylene and tetrafluoroethylene known commercially as VITON® B, and (3) a class of tetrapolymers of vinylidenefluoride, hexafluoropropylene, tetrafluoroethylene and a cure site monomer. The cure site monomer can be those available from DuPont such as 4-bromoperfluorobutene-1,1,1-dihydro-4-bromoperfluorobutene-1,3-bromoperfluoropropene-1,1,1-dihydro-3-bromoperfluoropropene-1, or any other suitable, known, commercially available cure site monomer. In another preferred embodiment, the fluoroelastomer is a tetrapolymer having a relatively low quantity of vinylidenefluoride. An example is VITON® GF, available from E.I. DuPont de Nemours, Inc. The VITON® GF has 35 weight percent of vinylidenefluoride, 34 weight percent of hexafluoropropylene and 29 weight percent of tetrafluoroethylene with 2 weight percent cure site monomer. Typically, these fluoroelastomers are cured with a nucleophilic addition curing system, such as a bisphenol crosslinking agent with an organophosphonium salt accelerator as described in further detail in the above-referenced Lentz patent and in U.S. Pat. No. 5,017,432. The fluoroelastomer is generally cured with bisphenol phosphonium salt, or a conventional aliphatic peroxide curing agent. Some of the aforementioned haloelastomers and others that can be selected include VITON® E45, AFLAS®, FLUOREL® I, FLUOREL® II, TECHNOFLON® and the like commercially-available haloelastomers. Similar polymers are available from 3M as Dynion products.

Unless otherwise indicated, the discussion herein of the hydrocarbon chains refers to the unreacted form. Each of the hydrocarbon chains (excluding any carbon atoms which may be in the functional groups) has, for example, from about 6 to about 14 carbon atoms, and preferably from about 8 to about 12 carbon atoms. The hydrocarbon chains are preferably saturated such as alkanes like hexane, heptane, decane, and the like. Each hydrocarbon chain may have one, two, or more functional groups, a functional group coupled to, for instance, an end carbon atom, to facilitate covalent bonding of the hydrocarbon chain to the backbone of the haloelastomer. It is preferred that each hydrocarbon chain has only one functional end group. The functional group or groups may be for instance —OH, —NH₂, —NRH, —SH, —NHCO₂, where R is hydrogen or a lower alkyl having, for example, from about 1 to about 4 carbon atoms. The hydrocarbon chains bonded to the haloelastomer can be similar or identical to the carrier fluids conventionally employed in liquid developers. About 85 to about 100 percent of the hydrocarbon chains are saturated, and particularly preferred, from about 95 to about 100 percent.

The fine fiber can be made of a polymer material or a polymer plus additive. One preferred mode of the invention is a polymer blend comprising a first polymer and a second, but different polymer (differing in polymer type, molecular weight or physical property) that is conditioned or treated at elevated temperature. The polymer blend can be reacted and formed into a single chemical specie or can be physically combined into a blended composition by an annealing process. Annealing implies a physical change, like crystallinity, stress relaxation or orientation. Preferred materials are chemically reacted into a single polymeric specie such that a Differential Scanning Calorimeter analysis reveals a single polymeric material. Such a material, when combined with a preferred additive material, can form a surface coating of the additive on the microfiber that provides oleophobicity, hydrophobicity or other associated improved stability when contacted with high temperature, high humidity and difficult operating conditions. The fine fiber of the class of materials can have a diameter of about 0.01 to 5 microns. Such microfibers can have a smooth surface comprising a discrete layer of the additive material or an outer coating of the additive material that is partly solubilized or alloyed in the polymer surface, or both. Preferred materials for use in the blended polymeric systems include nylon 6; nylon 66; nylon 6-10; nylon (6-66-610) copolymers and other linear generally aliphatic nylon compositions. A preferred nylon copolymer resin (SVP-65 1) was analyzed for molecular weight by the end group titration. (J. E. Walz and G. B. Taylor, determination of the molecular weight of nylon, Anal. Chem. Vol. 19, Number 7, pp 448-450 (1947). A number average molecular weight (Mₙ) was between 21,500 and 24,800. The composition was estimated by the phase diagram of melt temperature of three component nylon, nylon 6 about 45%, nylon 66 about 20% and nylon 610 about 25%. (Page 286, Nylon Plastics Handbook, Melvin Kohan ed. Hanser Publisher, New York (1995)).

Reported physical properties of SVP 651 resin are:

| Property | ASTM Method | Units | Typical Value |
|---|---|---|---|
| Specific Gravity | D-792 | — | 1.08 |
| Water Absorption | D-570 | % | 2.5 |
| (24 hr immersion) | | | |
| Hardness | D-240 | Shore D | 65 |
| Melting Point | DSC | ° C. (° F.) | 154 (309) |
| Tensile Strength | D-638 | MPa (kpsi) | 50 (7.3) |
| @ Yield | | | |
| Elongation at Break | D-638 | % | 350 |
| Flexural Modulus | D-790 | MPa (kpsi) | 180 (26) |
| Volume Resistivity | D-257 | ohm-cm | 10¹² |

We have found that additive materials can significantly improve the properties of the polymer materials in the form of a fine fiber. The resistance to the effects of heat, humidity, impact, mechanical stress and other negative environmental effect can be substantially improved by the presence of additive materials. We have found that while processing the microfiber materials of the invention, that the additive materials can improve the oleophobic character, the hydrophobic character and can appear to aid in improving the chemical stability of the materials. We believe that the fine fibers of the invention in the form of a microfiber are improved by the presence of these oleophobic and hydrophobic additives as these additives form a protective layer coating, ablative surface or penetrate the surface to some depth to improve the nature of the polymeric material. We believe the important characteristics of these materials are the presence of a strongly hydrophobic group that can preferably also have oleophobic character. Strongly hydrophobic groups include fluorocarbon groups, hydrophobic hydrocarbon surfactants or blocks and substantially hydrocarbon oligomeric compositions. These materials are manufactured in compositions that have a portion of the molecule that tends to be compatible with the polymer material affording typically a physical bond or association with the polymer while the strongly hydrophobic or oleophobic group, as a result of the association of the additive with the polymer, forms a protective surface layer that resides on the surface or becomes alloyed with or mixed with the polymer surface layers. For 0.2-micron fiber with 10% additive level, the surface thickness is calculated to be around 50 Å, if the additive has migrated toward the surface. Migration is believed to occur due to the incompatible nature of the oleophobic or hydrophobic groups in the bulk material. A 50 Å thickness appears to be reasonable thickness for protective coating. For 0.05-micron diameter fiber, 50 Å thickness corresponds to 20% mass. For 2 microns thickness fiber, 50 Å thickness corresponds to 2% mass. Preferably the additive materials are used at an amount of about 2 to 25 wt. %. Oligomeric additives that can be used in combination with the polymer materials of the invention include oligomers having a molecular weight of about 500 to about 5000, preferably about 500 to about 3000 including fluorochemicals, nonionic surfactants and low molecular weight resins or oligomers. A useful material for use as an additive material in the compositions of the invention is tertiary butylphenol oligomers. Such materials tend to be relatively low molecular weight aromatic phenolic resins. Such resins are phenolic polymers prepared by enzymatic oxidative coupling. The absence of methylene bridges result in unique chemical and physical stability. These phenolic resins can be crosslinked with various amines and epoxies and are compatible with a variety of polymer materials. Examples of these phenolic materials include Enzo-BPA, Enzo-BPA/phenol, Enzo-TBP, Enzo-COP and other related phenolics were obtained from Enzymol International Inc., Columbus, Ohio.

An extremely wide variety of flexible fabric materials exist for different cleaning and polishing applications. The durable nanofibers and microfibers described in this invention can be added to any of the fabrics. These fabrics can be woven or non-woven. The fabrics can be single layer or multiplayer. Each layer can comprise a single component woven or non-woven fiber or a blended, woven or non-woven fiber. The fabric layers can be combined with an interior non-fiber layer such as a sponge, a scrubbing mesh layer, a film barrier layer or a reservoir layer. The fabrics can be combined with a handle, support or a block to aid in cleaning or polishing.

The barrier fine fiber layer construction according to the present invention includes a first layer of a permeable fabric substrate having a first surface. A first layer of fine fiber is secured to the first surface of the first layer of fabric. Preferably the first layer of fabric comprises fibers having an average diameter of at least 10 microns, typically and preferably about 12 (or 14) to 30 microns. Also preferably the first layer of permeable fabric comprises a layer having a basis weight of no greater than about 100 grams/meter², preferably about 40 to 80 g/m², and most preferably at least 20 g/m². Preferably the first layer of permeable fabric is at least 0.008 inch (200 microns) thick, and typically and preferably is about 0.01 to 0.05 inch (10³ microns) thick.

The microfiber or nanofiber of the unit can be formed by the common electrostatic spinning process or processes for forming melt blown fiber, or using splittable fiber “island in a sea” methods.

Barris, U.S. Pat. No. 4,650,506, details the apparatus and method of the electrostatic spinning process and is expressly incorporated herein by reference. Apparatus used in such process includes a reservoir in which the fine fiber forming polymer solution is contained, a pump and a rotary type emitting device or emitter to which the polymeric solution is pumped and applied. The emitter generally consists of a rotating portion. The rotating portion then obtains polymer solution from the reservoir, and as it rotates in the electrostatic field, the electrostatic field, as discussed below, accelerates a droplet of the solution toward the collecting fabric surface. Facing the emitter, but spaced apart therefrom, is a substantially planar grid upon which the collecting surface (i.e. fabric or multilayer of multifiber fabric is positioned. Air can be drawn through the grid. The collecting surface is positioned adjacent opposite ends of grid. A high voltage electrostatic potential is maintained between emitter and grid by means of a suitable electrostatic voltage source.

In use, the polymer solution is pumped to the rotating portion from reservoir. The electrostatic potential between grid and the emitter imparts a charge to the material that cause liquid to be emitted therefrom as thin fibers which are drawn toward grid where they arrive and are collected on substrate fabrics. In the case of the polymer in solution, solvent is evaporated off the fibers during their flight to the grid; therefore, the fibers arrive at the fabric. The fine fibers bond to the fabric fibers first encountered at the grid. Electrostatic field strength is selected to ensure that the polymer material as it is accelerated from the emitter to the fabric; the acceleration is sufficient to render the material into a very thin microfiber or nanofiber structure. Increasing or slowing the advance rate of the collecting fabric can deposit more or less emitted fibers on the forming fabric, thereby allowing control of the thickness of each layer deposited thereon.

The thermoplastic polymer materials on the invention can be melt spun or melt blown into fine fiber materials. In such processes the melt polymer is transformed into a long continuous thread and cools and solidifies into a fiber, collection of fiber or fiber bundle. Useful polymer is thermally and chemically sable under high-temperature spinning conditions. The temperature of spinning is sufficiently high to permit polymer flow through a nozzle or nozzle openings. Preferably the liquid thread, after spinning, remains intact until solidification occurs. Typically any spun thread is highly extendable during melt processing and afterwards. In order to achieve successful melt spinning properties, fluid velocity, Newtonian behavior and viscosity or controlled to maintain a stable melt thread production. Such fiber forming processes are known and have been used for many years in producing fine fiber materials. Basic polymer processing technology as discussed in McKelvey, J. M., Polymer Processing (Wiley, NY 1962), Pearson, J. R. A., Mechanical Principles Of Polymer Melt Processing, (Oxford, 1966) and other publications. The melt blown process is well known and is described in various patents and publications, including NRL Report 4364, “Manufacture of Super-Fine Organic Fibers” by V. A. Wendt, E. L. Boon, and C. D. Fluharty; NRL Report 5265, “An Improved Device for the Formation of Super-Fine Thermoplastic Fibers” by K. D. Lawrence, R. T. Lukas, and J. A. Young; and U.S. Pat. No. 3,849,241 issued Nov. 19, 1974, to Buntin, et al.

Once formed on a substrate using either electro-spinning or melt blown techniques, the fine fiber layer can be used as is on the flexible substrate. One preferred substrate comprises the air permeable aerosol barrier or any other substrate that does not substantially reduce permeability. Such a substrate can have an air permeability that is greater than or matches the aerosol barrier layer. Alternately, the fine fiber layer can be removed from the substrate and adhered into the structures of the invention. When use in such a form, the fine fiber layer is typically used and adhered between an inner layer and an outer layer such as that shown in FIGS. 18 and 19.

Outer Shell

Typically, the outer shell is a light fabric having a weight of about 0.5 oz/sq yard to about 20 oz/sq. yd., preferably about 1 oz/sq. yd. to about 10 oz/sq. yd. Both woven and non-woven fabrics can be used, however, a preferred fabric is a light woven fabric. For example, the outer shell can be, for example, cotton, nylon, polyester, polyethylene, polypropylene, acrylic fibers, PVC fibers, and blends of such materials, or any other fabric or blend of fabrics. Such fibers can be woven into a fabric and can have a patterned or dyed appearance.

Typically, the outer shell has a defined air permeability of about 2 fpm to about 100 fpm, preferably about 5 fpm to about 20 fpm. The outer layer preferably has a thickness ranging, for example, from about 0.1 to about 10 mils, preferably from about 0.2 to about 5 mils, and more preferably from about 1 to about 3 mils.

The air permeability of the outer shell can determine the rate of flow of air exchange through the garment, which in embodiments using a reactive layer (described below) may be necessary to maximize the filtering capability of the adsorbing agent. The shell may provide other functionality, such as a exhibiting a camouflage pattern, a bright color, and may provide protection to the wearer from sharp objects, debris and soil. The shell fabric may be treated with fluorocarbon or other protective treatments such as Quarpel, Scotchgard or other materials to improve the resistance of the fabric to liquid splashes and dirt.

Preferred fabrics for use in this invention are light nylon/cotton-blended fabrics that are available from HL Landau. One example of an outer shell is a camouflage dyed nylon/cotton-blended, wind-resistant poplin having a weight of about 7 oz/sq yd. This outer shell specifications are described in MIL-C-44436(GL).

Multilayer Fine Fiber Layer/Outer Shell

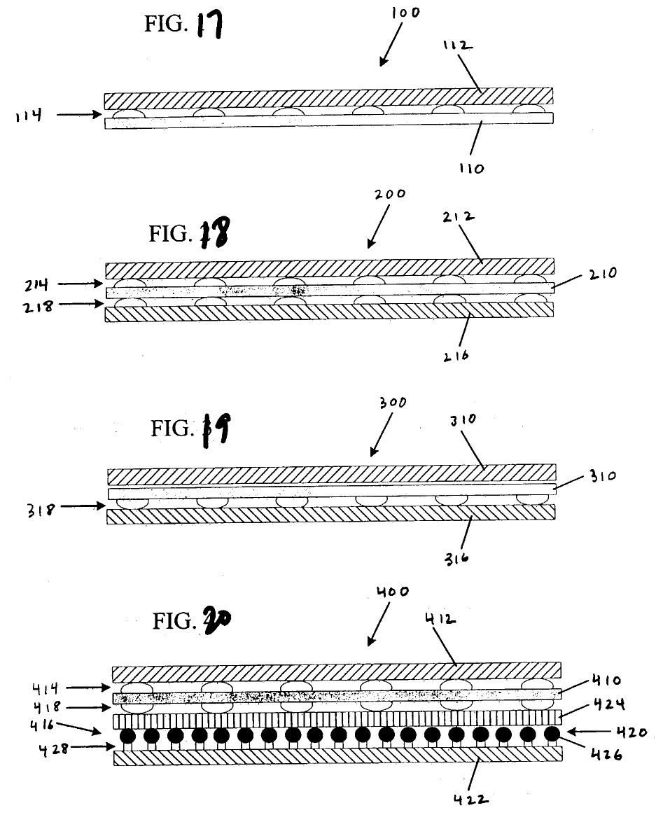

Referring to FIG. 17, a multilayer fabric 100 is shown. The multilayer fabric includes a fine fiber layer 110 adhered to an outer shell 112 with a discontinuous adhesive 114. Discontinuous adhesive 114 typically covers about 10 to about 50%, and preferably about 30 to about 45%, of the surface area of the fine fiber layer 110. Discontinuous adhesive does not seal the fine fiber layer 110 with adhesive, allowing for air permeabilities between about 0.25 fpm to about 150 fpm. Preferably, air permeabilities range from about 2 fpm to about 50 fpm. With this multilayer fabric construction, the pores of the fine fiber layer 110 are substantially free from any adhesive or other composition, such as hydrophilic polyurethane materials. The fine fiber layer 110 is adhered to the outer shell 112 and not laminated with a continuous layer of adhesive or resin that would lower air permeabilities to about zero. Alternative means of achieving adherence of the layers may be used, such as use of use of an adhesive web or thermal lamination. In other constructions, the discontinuous adhesive can be eliminated and the fine fiber layer and outer shell can be positioned next to one another as separate layers without any method of attachment, adherence, lamination, or connection. In another embodiment, the fine fiber layer and outer shell can be sewn together as the fine fiber layer as an alternative to the adherence method of connection.

Multilayer fabrics that include an outer shell adhered to the fine fiber layer can have has a defined air permeability of about 0.25 fpm to about 100 fpm, preferably about 2 fpm to about 50 fpm, and a filtration efficiency (LEFS) of greater than about 50% to about 80%, preferably greater than about 90%. Air permeability and filtration efficiency are measured according to ASTM D737-96 and ASTM F1215-89, respectively.

Interior Fabric Layer

Referring to FIG. 18, an optional interior fabric layer 216 (interior comfort layer or skin contact layer) can be included with a fine fiber layer 210 and an outer shell 212, as shown in a second embodiment of a multilayer fabric 200. The interior fabric layer 216 can comprise the same or a different material as the material used for the outer shell 212. The interior fabric layer 216 can be laminated to the fine fiber layer 210 with a discontinuous adhesive 218. In multilayer fabrics that include a discontinuous adhesive between the fine fiber layer and outer shell, the discontinuous adhesive between the fine fiber layer and the interior fabric layer is a second discontinuous adhesive. Outer shell 212 is laminated to a fine fiber layer 210 with a discontinuous adhesive 214 similar to discontinuous adhesive 114 of FIG. 17. This inner layer protects the fine fiber layer from contamination by body oils and skin debris. Such materials can plug pores and reduce permeability.

Typically, the interior fabric layer is a light fabric having a weight of about 0.3 oz/sq yd. to about 6 oz/sq. yd., preferably about 0.3 to about 2 oz./sq. yd. Both woven and non-woven (including knit) fabrics can be used, however, a preferred fabric is a light knit fabric. For example, the interior fabric layer can be, for example, cotton, nylon, polyester, polyethylene, polypropylene, acrylic fibers, PVC fibers, and blends of such materials, or any other fabric or blend of fabrics. Such fibers can be woven into a fabric and can have a patterned or dyed appearance. The interior fabric layer may be in contact with the wearer's skin when used as an overgarment or undergarment and can be made from a material that provides comfort to the wearer.

Typically, the interior fabric layer has a defined air permeability of about 0.1 fpm to about 200 fpm, preferably about 20 to about 1000. Air permeability and filtration efficiency are measured according to ASTM D737-96 and ASTM F1215-89, respectively.

In applications that utilize the multilayer fabric as an undergarment, the interior fabric layer is next to and in contact with a wearer's skin and is typically made from a comfortable material such as tricot knit nylon. If the multilayer fabric is used as an overgarment, the interior fabric layer may be still be in contact with portions of the wearer's skin and, in those applications, a comfortable material is typically used.

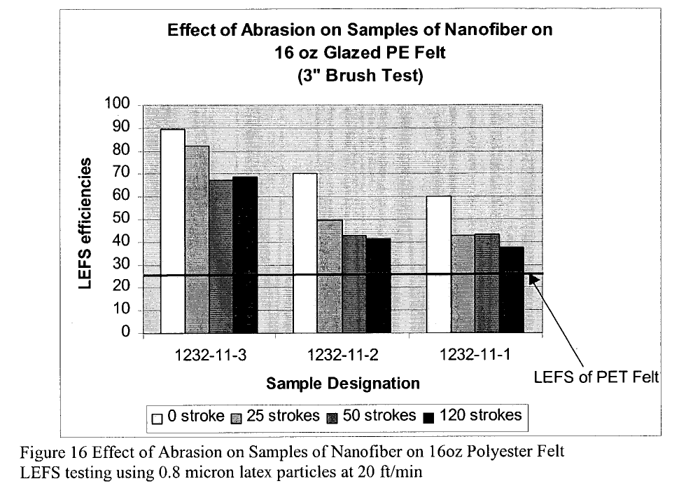

In other embodiments of a multilayer fabric, such as multilayer fabric 300, shown in FIG. 16, the discontinuous adhesive, such as discontinuous adhesive 214 of FIG. 17, between outer shell 312 and fine fiber layer 310 can be eliminated. Alternatively, the layers can be sewn together. Discontinuous adhesive 318 can optionally be included to laminate the interior fabric layer 316 to the fine fiber layer 310, but also can be eliminated.

Referring to FIG. 20, interior fabric layer 416 can include an optional reactive layer 420 including small particulates 426. Reactive layer 420 is described below. The reactive layer 420 is typically disposed between an inner layer 422 and an outer layer 424 of interior fabric layer 416. This three-layer construction forms the interior fabric layer 416, which is optionally adhered to fine fiber layer 410 with a discontinuous adhesive 418 similar to discontinuous adhesives 218, 318 of FIGS. 17 and 18.

Outer layer 424 is optional and can be any woven or non-woven cover that retains the reactive layer. Alternatively, the fine fiber layer 410 can substitute for outer layer 424. FIG. 20 shows a discontinuous adhesive 428 that adheres particles of the reactive layer 420 to inner layer 422. Alternatively, the reactive layer can be sandwiched between the inner layer and outer layer or the inner layer and fine fiber layer without the use of an adhesive or adhered directly to fine fiber layer 410 or outer layer 424.

Reactive Layer

Referring to FIG. 20, an optional reactive layer 420 can be used in the laminated fabric 400. Reactive layers can be used to absorb, adsorb, or react with chemical or biological agents. Reactive layer 420 of the invention typically includes a finely divided activated carbon material dispersed, adhered to or embedded into a woven or non-woven material of the laminate, although other materials can be used in the reactive layer. The reactive layer 420 can be formed from the individualized particles of material such as particulates 426 of FIG. 20. Chemically reactive layers might include enzymes, catalysts, ion exchange materials, zeolites, etc.

Preferred reactive agents used in the invention include activated carbon and molecular sieve zeolite materials. The absorbent or adsorbent material is more preferably an activated small divided carbon particulate. Such a particulate can have a grain size typically ranging from about 0.1 to 1 mm, preferably averaging about 0.2 to 0.4 mm. Activated carbon in other forms can be used depending on the desired characteristics of the multilayer fabric.

The activated carbon adsorbent can be combined with other absorbing or adsorbing organic or inorganic reagents for use in the laminate of the invention. Such materials can include sodium, potassium, calcium and other salts of bicarbonate, carbonate, hydrogen phosphate, dihydrogen phosphate, phosphate, sulfate, sulfite, ascorbic acid, boric acid, citric acid, small particle ion exchange resins and other materials that can be used to act as a barrier to the passage of hazardous vapors or gases. Active carbon can be prepared in a known manner from suitable organic materials.

The absorbent layer can be formed on a woven or non-woven fabric or web. A non-woven web useful as a carrier for the absorbent material can include spun bond webs, carded bonded webs, webs comprising fabrics or fibers having a fiber diameter that can comprise about 1 to 500 microns, preferably about 10 to about 200 microns.

If the reactive layer is adhered to a supporting material, the applied adhesive should cover about 20 to 50 %, preferably 20 to 35 %, of the surface of the supporting material. This partial application of the adhesive can be achieved by applying the adhesive only to the prominences of a fabric serving as a textile support material. Alternatively, a printed pattern can be distributed on the supporting material in the form of dots or lines. By the choice of the pattern it is possible to create a geometry that provides for absorption/adsorption, and taken into account characteristics of breathability, which relate to the surface area of supporting material not covered in adhesive. Typically, the amount of adhesive applied is constant and uniform over the entire width of the supporting material. The pattern of the adhesive has a thickness of about 0.1 mm to about 0.4 mm and a diameter or width of about 0.1 mm to 1 mm, preferably about 0.3 mm to about 0.6 mm. The adhesive is best applied in dot form and the dots of adhesive are of hemispherical or conical shape.

A layer of material which has both adsorbents and suitable enzymes can be especially appropriate for protection against chemical and/or biological warfare agents. Enzymes can be used to decompose harmful gases such as mustard gas and nerve poisons and may deactivate biological agents.

Enzymes can be applied to supporting materials in the same manner in which the reactive layer is applied, ensuring that the components of the adhesive do not damage the membranes or the enzyme itself and avoiding the use of elevated temperatures during the manufacturing process. In some multilayer materials, the adsorbent is applied to a supporting layer and then the encapsulated gel spheres containing the enzyme are applied to the untreated side of the supporting layer. Additionally, enzymes or other active chemistry can cover the fine fiber layer with the multilayer fabric retaining an air permeability above 1.

Adhesives The adhesive used to laminate layers of material or particles to other layers of material can be either a polyurethane hot melt adhesive or a solvent based polyurethane adhesive. Examples of holt melt adhesives include, but are not limited to, TYFORCE H-1041, NH-122A, NH-300. TYFORCE adhesive can be obtained from Dainippon Ink & Chemicals, Inc. (Japan). Another example of a hot melt adhesive is TACKTILE made by H. B. Fuller Company as S12/4, S12/3 and 9136 providing acceptable bond strength and fabric layer integrity. Hot melt polyurethane adhesives are typically applied to a material as a discontinuous dot pattern.

Other Fabric Treatments and Materials

Fabrics can optionally be treated with silicones, fluorocarbons, and other water repellents, which usually allow evaporation of perspiration but are only marginally waterproof, they allow water to leak through them under very low pressures, and usually leak spontaneously when rubbed or mechanically flexed. The outer shell can be treated to provide fire retardancy, shed large droplets or aerosols of rain and/or chemical and biological warfare agents. For example, the shell fabric may be treated with a fluorocarbon treatment such as Quarpel and have a repellency rating of 100, 100, 90 per AATCC 22 (Spray rating)(ISO 4920).

The fabric can also be constructed with flame retardant elements. For example, commercially available flame retardant adhesives can be used with fabrics made from fire retardant fibers such as meta-aramids, para-aramids, polybenzimidazole, and various blends of these types of fibers. Fire retardant fabrics can include, for example, Nomex, Kevlar, and PBI.

One example of a flame retardant fabric includes a fine fiber layer adhered to a 4.5 OSY Nomex/Kevlar (95/5) shell available from Springs Industries using a discontinuous adhesive S12/4 from H.B. Fuller with halogen free fire retardant additives. Alternatively, the fine fiber layer can be adhered to a 1.7 OSY Nomex/Kevlar (95/5) warp knit available from SSM Industries.

### EXAMPLES

We have established parameters for the nanofiber layer's permeability, particle barrier properties. We believe that we understand the process and materials loptimization of the nanofiber process. We have focused on the porosity, fiber size, polymer, production process, and lamination of the products.

Simplified Fabrics

An initial screening was run with simplified fabric samples, a nanofiber layer on a supporting frabric with no covering layer. A range of nanofiber types, sizes, and substrates was tested for permeability and particle barrier properties. The particle barrier properites were measured before and after each durability test. Results of some of the runs are shown in Table 1. The runs used a variety of nylon polymers and additives.

TABLE 1
Example Simplified Fabric Durability Results
Durability Test Results
Test Method is LEFS efficiency with
0.8 micron latex particles at 20 ft/min.

| Run | | | | Fiber | LEFS | |
|---|---|---|---|---|---|---|
| No. | Polymer | Solids | Substrate | Size | Eff | Perm |
| 1 | 1 | 13 | Cerex 100 | 0.349 | 79.98 | 86.6 |
| 2 | 1 | 13 | Cerex 300 | 0.351 | 78.78 | 62.7 |
| 3 | 1 | 10.6 | Cerex 100 | 0.284 | 88.85 | 87.3 |
| 4 | 1 | 10.6 | Cerex 300 | 0.296 | 90.18 | 61.7 |
| 5 | 2 | 10.6 | Cerex 100 | 0.277 | 87.2 | 90.9 |
| 6 | 2 | 10.6 | Cerex 300 | 0.291 | 89.38 | 56.5 |
| 7 | 2 | 13 | Cerex 100 | 0.361 | 70.78 | 107.0 |
| 8 | 2 | 13 | Cerex 300 | 0.407 | 60.04 | 83.7 |
| 9 | 3 | 13 | Cerex 100 | 0.321 | 76.42 | 114.9 |
| 10 | 3 | 13 | Cerex 300 | 0.319 | 83.32 | 63.7 |
| 11 | 3 | 16 | Cerex 100 | 0.319 | 87.27 | 62.3 |
| 12 | 3 | 16 | Cerex 300 | 0.34 | 87.8 | 44.6 |
| 13 | 3 | 17 | Cerex 100 | 0.385 | 48.78 | 139.9 |

Cerex 100 is Cerex 1.0 ounce per square yard type 23 spunbonded fabric from Cerex Advanced Fabrics, L.P. Cerex 300 is Cerex 3.0 ounce per square yard type 23 spunbonded fabric from Cerex Advanced Fabrics, L.P. Both fabrics are composed of nominally 4 denier Nylon 66 fibers. Perm is Frazier permeability in CFM/sq ft at 0.5 inch of water restriction. Polymer 1 is a blend of a co-polymer of nylon 6, 66, 610 and copolymer of nylon 6, 66, 69. Polymer 2 is a blend of polymer 1 and a poly(t-butyl phenol) additive. Polymer 3 is a blend of alkoxy-alkyl modified nylon 66 with copolymer of nylon 6,66,610.

The choice of nanofiber polymer is important for adhesion and wears resistance, requiring the ability to survive the environment, and the ability to stretch and recover with supporting layer movement.

In forming a durable effective gas and aerosol barrier combined with flexibility and long life, we have found that the fluoropolymer fiber materials can be effectively used alone and in concert with other fine fiber materials. We have found that the fluoropolymer materials are flexible at common use temperatures that range from −10° C. to extreme temperatures of desert conditions. The flexibility of the polymer materials makes the durability of fabrics used in an active military environment quite durable and long-lived when stressed during times of very high activity.

In addition, we have found that the combination of a fluoropolymer fine fiber with a second fine fiber tends to stabilize the dual layer of fine fiber into a more stable embodiment.

A series of fabric examples were prepared by spinning nylon fine fiber, fluoropolymer fine fiber or a combination of a nylon and a fluoropolymer fine fiber into a fabric for testing for efficiency pressure drop and permeability. The resulting fabrics appear to have substantially improved durability when a combined fluoropolymer nylon layer was used.

SPINNING EXPERIMENTAL
SPINNING COMPOSITION

| | Solution 1 | | | Solution 2 NYLON | | |
|---|---|---|---|---|---|---|
| | | | Viscosity | | | Viscosity |
| Sample | Composition | Preparation | (cps) | Composition | Preparation | (cps) |
| 1 | none | — | — | ethanol | Vigorous | 46 |
| | | | | solution | stirring for | |
| | | | | | 2 hrs at | |
| | | | | | 45° C. | |
| 2 | none | — | — | ethanol | Vigorous | ″ |
| | | | | solution | stirring for | |
| | | | | | 2 hrs at | |
| | | | | | 45° C. | |
| 3 | 10% FC | Vigorous | 19 | ethanol | Vigorous | ″ |
| | 2261Q in | stirring for | | solution | stirring for | |
| | acetone | 2 hrs at | | | 2 hrs at | |
| | W_{(polymer)}/ | 45° C. | | | 45° C. | |
| | W₍ₛₒₗᵤₜᵢₒₙ₎ | | | | | |
| 4 | 10% FC | Vigorous | ″ | ethanol | Vigorous | ″ |
| | 2261Q in | stirring for | | solution | stirring for | |
| | acetone | 2 hrs at | | | 2 hrs at | |
| | W_{(polymer)}/ | 45° C. | | | 45° C. | |
| | W₍ₛₒₗᵤₜᵢₒₙ₎ | | | | | |
| 5 | 10% FC | Vigorous | ″ | — | — | — |
| | 2261Q in | stirring for | | | | |
| | acetone | 2 hrs at | | | | |
| | W_{(polymer)}/ | 45° C. | | | | |
| | W₍ₛₒₗᵤₜᵢₒₙ₎ | | | | | |
| 6 | 10% FC | Vigorous | ″ | — | — | — |
| | 2261Q in | stirring for | | | | |
| | acetone | 2 hrs at | | | | |
| | W_{(polymer)}/ | 45° C. | | | | |
| | W₍ₛₒₗᵤₜᵢₒₙ₎ | | | | | |
| 7 | 10% FC | Vigorous | ″ | | | 46 |
| | 2261Q in | stirring for | | | | |
| | acetone | 2 hrs at | | | | |
| | W_{(polymer)}/ | 45° C. | | | | |
| | W₍ₛₒₗᵤₜᵢₒₙ₎ | | | | | |
| 8 | 10% FC | Vigorous | ″ | ″ | ″ | ″ |
| | 2261Q in | stirring for | | | | |
| | acetone | 2 hrs at | | | | |
| | W_{(polymer)}/ | 45° C. | | | | |
| | W₍ₛₒₗᵤₜᵢₒₙ₎ | | | | | |
| 9 | No fine | — | — | — | — | — |
| (camouflage | fiber | | | | | |
| only) | | | | | | |

FC 2261Q is a copolymer of vinylidene fluoride and hexafluoropropylene made by 3M ® that is similar to Viton ® A.

SPINNING CONDITIONS

| | | | | | | | | Fine fiber | |
|---|---|---|---|---|---|---|---|---|---|
| | | | | | | | Web | layer | |
| Relative | T | | | | | Distance | Speed | deposition | Post |
| Humidity | (0° F.) | Voltage (Kv) | | Pump Rate (cc/min) | | (in.) | (ft/min) | order | treatment |
| 36% | 72 | FP | NYLON | FP | NYLON | | | | |
| ″ | ″ | 50 | 45 | — | 3 | 4 | 7 | Nylon | — |
| ″ | ″ | 50 | 45 | — | 3 | 4 | 7 | Nylon | 10 min at |
| | | | | | | | | | 250° F. |
| ″ | ″ | 50 | 45 | 10 | 3 | 4 | 7 | Nylon/FluoroP | — |
| ″ | ″ | 50 | 45 | 10 | 3 | 4 | 7 | ″ | 10 min at |
| | | | | | | | | | 250° F. |
| ″ | ″ | 50 | 45 | 10 | — | 4 | 7 | FluoroP | — |
| ″ | ″ | 50 | 45 | 10 | — | 4 | 7 | ″ | 10 min at |
| | | | | | | | | | 250° F. |
| ″ | ″ | 50 | 45 | 10 | 3 | 4 | 7 | FluoroP/Nylon | — |
| ″ | ″ | 50 | 45 | 10 | 3 | 4 | 7 | ″ | 10 min at |
| | | | | | | | | | 25° F. |
| — | — | — | — | — | — | — | — | — | — |

TABLE 3
Fluoropolymer fine fiber layers - Optionally with a nylon layer

| | | | Pressure | |
|---|---|---|---|---|
| Sample | | Efficiency | drop (in. | |
| 1226-36- | Fine fiber layer | 0.4 micron | H₂O) | |
| 1-9 | deposition order | efficiency | Change in P | Permeability |
| Example 1 | Nylon | 84.39 | 1.592 | 7.49 |
| Example 2 | Nylon | 74.57 | 1.473 | 7.93 |
| Example 3 | Nylon/Viton | 90.23 | 1.775 | 7.13 |
| Example 4 | Nylon/Viton | 76.81 | 1.629 | 6.68 |
| Example 5 | Viton | 58.51 | 1.559 | 6.7 |
| Example 6 | Viton | 32.93 | 1.586 | 9.17 |
| Example 7 | Viton/Nylon | 95.86 | 1.891 | 6.4 |
| Example 8 | Viton/Nylon | 90.17 | 1.754 | 6.91 |
| Example 9 | No Fine fiber | 32.48 | 1.576 | 8.5 |
| (camouflage | | | | |
| Fabric only) | | | | |

These data show that the use of the combined fluoropolymer and nylon fine fiber in a dual layer fine fiber structure obtains substantial efficiency, low pressure drop and very high permeability leading us to conclude that the fabrics made with this dual fine fiber technology will be surprisingly adaptable to active operations in the military and the civilian environment.

The Figures, examples, data and other technical disclosure provides a basis for understanding the nature of the invention. Many embodiments can be made without departing from the spirit and the nature of the invention. The invention resides in the claims hereinafter appended.

We claim:

1. A fabric comprising:
(a) a fine fiber layer having a fiber size of 0.005 to 1μ, a basis weight of 1.2×10⁻⁴ to 3.5 mg-cm⁻² and an average pore size of 0.5 to 20μ; and
(b) an outer shell protecting the fine fiber layer;
wherein the fabric has an air permeability greater than about 1.

2. The fabric of claim 1, wherein the fine fiber layer is combined with a substrate layer.

3. The fabric of claim 1, wherein the air permeability of the fabric is about 1 and 500, and the fine fiber has a layer thickness of about 0.05 to 30 microns.

4. The fabric of claim 1, wherein the air permeability of the fabric is between about 5 and 1000, and the fine fiber has a layer thickness of about 0.1 to 5 microns.

5. The fabric of claim 1, further comprising an inner comfort layer, the fabric comprising a discontinuous adhesive between the fine fiber layer and the inner layer, the adhesive applied to allow air permeability

6. The fabric of claim 1, further comprising a discontinuous adhesive between the fine fiber layer and the outer shell applied to allow air permeability.

7. The fabric of claim 5, wherein the discontinuous adhesive covers about 10 to 50 percent of the fine fiber layer.

8. The fabric of claim 1, further comprising a reactive layer to remove harmful agents.

9. The fabric of claim 8, further comprising a discontinuous adhesive between the fine fiber layer and the reactive layer, the adhesive applied to allow air permeability.

10. The fabric of claim 8, wherein the harmful agent is a gas phase chemical.

11. The fabric of claim 8, wherein the harmful agent is a biologically active agent.

12. The fabric of claim 1, wherein the outer shell at least partially comprises a fire retardant fiber.

13. The fabric of claim 5, wherein the inner comfort layer at least partially comprises a fire retardant fiber.

14. A fabric comprising:
(a) a fine fiber layer having a fiber size of 0.05 to 1 micron, a basis weight of 1.25×10⁻⁴ to 3.5 mg-cm⁻² and an average pore size of 0.5 to 20 micron;
(b) an outer shell protecting the fine fiber layer and an inner layer; and
(c) a reactive layer between the inner layer and the fine fiber layer.

15. The fabric of claim 14, wherein the fine fiber layer is combined with a substrate layer, and the air permeability is about 5 to 100.

16. The fabric of claim 14, wherein the fabric has an air permeability of greater than 1.

17. The fabric of claim 14, wherein the outer shell at least partially comprises fire retardant fibers.

18. The fabric of claim 14, wherein the inner layer at least partially comprises fire retardant fibers.

19. A fabric comprising:
(a) an outer shell;
(b) a fine fiber layer adhesively secured to the outer shell with a discontinuous adhesive; and
(c) an interior fabric layer comprising:
(1) an inner layer;
(2) an outer layer; and
(3) a reactive layer disposed between the inner layer and the outer layer.

20. The fabric of claim 19, wherein the fine fiber layer is combined with a substrate layer, and the air permeability of the fabric is about 5 to 100.

21. The aerosol barrier fabric of claim 19, further comprising a second discontinuous adhesive securing the interior fabric layer to the fine fiber layer.

22. The fabric of claim 19, wherein the outer shell at least partially comprises fire retardant fibers.

23. The fabric of claim 19, wherein the interior comfort layer at least partially comprises fire retardant fibers.

24. A fabric comprising a substrate having a fine fiber layer comprising:
(a) a first layer comprising a thermoplastic polymer having a fiber size of 0.005 to 1μ, a basis weight of 1.2×10⁻⁴ to 3.5 mg-cm⁻² and an average pore size of 0.5 to 20μ;
(b) a second layer comprising a polymeric elastomer having a fiber size of 0.005 to 1μ, a basis weight of 1.2×10⁻⁴ to 3.5 mg-cm⁻² and an average pore size of 0.5 to 20μ;
wherein the fabric has an air permeability of greater than about 1.

25. The fabric of claim 24, wherein the elastomer is a polyurethane.

26. The fabric of claim 24, wherein the elastomer is a fluoropolymer.

27. The fabric of claim 24, wherein the air permeability of the fabric is between about 5 and 100, and the fine fiber has a layer thickness of about 0.1 to 5 microns.

28. The fabric of claim 24, wherein the elastomer is crosslinked.

29. The fabric of claim 24, wherein the fabric comprises:
(c) an outer shell protecting the fine fiber layer; and
(d) a fabric having an air permeability greater than about 2.

30. The fabric of claim 29, wherein the air permeability of the fabric is between about 3 and 500, and the fine fiber has a layer thickness of about 0.05 to 30 microns.

31. The fabric of claim 29, wherein the air permeability of the fabric is between about 5 and I 00, and the fine fiber has a layer thickness of about 0.1 to 5 microns.

32. The fabric of claim 29, further comprising an inner layer, the fabric comprising a discontinuous adhesive between the fine fiber layer and the inner layer is applied to allow air permeability

33. The fabric of claim 29, further comprising a discontinuous adhesive between the fine fiber layer and outer shell applied to allow air permeability.

34. The fabric of claim 32, wherein the discontinuous adhesive covers about 10 to 50 percent of the fine fiber layer.

35. The fabric of claim 29, further comprising a reactive layer to remove harmful agents.

36. The fabric of claim 35, further comprising a discontinuous adhesive between the fine fiber layer and the reactive layer applied to allow air permeability.

37. The fabric of claim 35, wherein the harmful agent is a gas phase chemical.

38. The fabric of claim 29, wherein the outer layer comprises a fire retardant fiber.

39. The fabric of claim 35, wherein the harmful agent is a biologically active agent.

40. A multilayer fabric comprising:
(a) a fine fiber layer having a fiber size of 0.05 to 1μ, a basis weight of 1.25×10⁻⁴ to 3.5 mg-cm⁻² and an average pore size of 0.5 to 20μ; and a layer comprising a fluoropolymer elastomer having a fiber size of 0.05 to 5μ, a basis weight of 1.2×10⁻⁴ to 15 mg-cm⁻² and an average pore size of 0.5 to 20μ;
(b) an outer shell protecting the fine fiber layer; and
(c) an inner layer; and
(d) a reactive layer between the inner layer and the fine fiber layer.

41. The fabric of claim 40, wherein the fine fiber layer is combined with a substrate layer.

42. The fabric of claim 40, wherein the fabric has an air permeability of greater than 1.

43. A fabric comprising:
(a) a first fine fiber layer comprising a first thermoplastic polymer having a fiber size of 0.005 to 1μ, a basis weight of 1.2×10⁻⁴ to 3.5 mg-cm⁻² and an average pore size of 0.5 to 20μ; and
(b) a second fine fiber layer comprising a second thermoplastic polymer having a fiber size of 0.005 to 1μ, a basis weight of 1.2×10⁻⁴ to 3.5 mg-cm⁻² and an average pore size of 0.5 to 20μ;

44. The fabric of claim 43, wherein the first fine fiber layer is combined with a substrate layer.

45. The fabric of claim 43, wherein the fabric comprises:
(c) an outer shell protecting the first fine fiber layer; and
(d) the aerosol barrier fabric having an air permeability greater than about 1.

46. The fabric of claim 43, wherein the air permeability is between about 1 and 500, and each fine fiber independently has a layer thickness of about 0.05 to 30 microns.

47. The fabric of claim 43, wherein the air permeability is between about 5 and 100, and each fine fiber layer independently has a layer thickness of about 0.1 to 5 microns.

48. The fabric of claim 45, further comprising a discontinuous adhesive between the fine fiber layer and outer shell applied to allow air permeability.

49. The fabric of claim 48, wherein the discontinuous adhesive covers about 10 to 50 percent of the fine fiber layer.

50. The fabric of claim 43, further comprising an inner comfort layer.

51. The fabric of claim 43, further comprising a reactive layer to remove harmful agents.

52. The fabric of claim 51, wherein the harmful agent is a gas phase chemical.

53. The fabric of claim 51, wherein the harmful agent is a biohazard chemical.

54. An aerosol barrier protective undergarment fabric comprising:
(a) a fine fiber layer, wherein the pores of the layer are sized to filter aerosols; and
(b) an inner comfort layer protecting the layer.

55. The fabric of claim 25, wherein the pores of the layer are greater than about 1 micron.

56. The fabric of claim 25, wherein the pores of the layer are between about 2 to 3 microns.

57. The fabric of claim 25 wherein the fabric is adapted to be worn on the body and covered by an exterior layer.
